(19) United States
(12) Patent Application Publication
(10) Pub. No.: US 2002/0184130 A1
(43) Pub. Date: Dec. 5, 2002

(54) Intellectual capital risk analysis system

(76) Inventor: John P. Blasko, New Hope, PA (US)

Correspondence Address: TECHNOLOGY, PATENTS AND LICENSING, INC., 340 NORTH BROAD STREET, DOYLESTOWN, PA, 18901, US

(21) Appl. No.: 10/116,736

(22) Filed: Apr. 4, 2002

Related U.S. Application Data
(60) Provisional application No. 60/281,536, filed on Apr. 4, 2001.

(51) Int. Cl. G06F 17/60

(52) U.S. Cl. 705/35

(57) ABSTRACT

A system, method and computer program product for processing data are described herein. The system has a first database with patent and patent application information as is typically found in patent docketing systems. The system also has a second database for storing information related to risk elements associated with the acquisition of inventions, the prosecution, maintenance and enforcement of patents, and the practicing of inventions. The second database may also contain information about patent prosecution transactions for one or more countries. Upon receiving the appropriate command, the system evaluates certain risks associated with a patent application, a group of patent applications, a patent and/or a group of patents to determine the risk level. The elements of risk may be weighted. The system graphically displays the weighted risk information such that the user has a visual indicator of the relative risks associated with a patent asset or a patent prosecution transaction.

### CROSS-REFERENCES

This application claims priority under 35 U.S.C. §1.19(e) for Provisional application No. 60/281,536 filed on Apr. 4, 2001 entitled “Intellectual Capital Risk Analysis”, which is herein incorporated by reference but not admitted to be prior art.

### FIELD OF THE INVENTION

The present invention relates to an intellectual capital management system for analyzing and evaluating risk associated with patents and patent applications.

### SUMMARY OF THE INVENTION

A system, method and computer program product for processing data is described herein. The system has a first database with patent and patent application information as is typically found in patent docketing systems. The system also has a second database for storing information related to risk elements associated with the acquisition of inventions, the prosecution, maintenance and enforcement of patents, and the practicing of inventions. The second database may also contain information about patent prosecution transactions for one or more countries. Upon receiving the appropriate command, the system evaluates certain risks associated with a patent application, a group of patent applications, a patent and/or a group of patents to determine the risk level relative thereto. The elements of risk may be weighted. The system graphically displays the weighted risk information such that the user has a visual indicator of the relative risks associated with a patent asset or a patent prosecution transaction. The risk analysis is useful for decision-making concerning resource planning with respect to patent prosecution, licensing, and enforcement.

The invention comprises a system for processing data having a means for accessing a first database of information representative of patent applications or patents. It also has a means of accessing a second database of information relating to risk elements associated with patent rights and a means for automatically evaluating the potential risks of at least one patent application, group of patent applications, patent, or group of patents represented in said first database.

The present invention may also have means for displaying risk information using a graphical display based on the potential risks associated with said at least one patent, group of patent applications, patent, or group of patents.

The risk evaluating means may comprise a means for correlating selected risk elements from said second database with information accessed from said first database, a means for assigning a weight to at least one of said selected risk elements on the basis of predetermined relationships existing between the elements of information in said second database, and a means for determining a risk level classification for said at least one selected risk element based on said assigned weight.

The selected risk elements are preferably associated with one or more of the following criteria:

patent status, patent prosecution status, one or more patent prosecution transactions, patent prosecution resources, financial resources, patent prosecution costs, patent prosecution expenditures, patent licensing status, patent licensing revenue, patent licensing obligations, patent acquisition costs, invention development costs, invention development expenditures, invention ownership status, patent litigation status, patent litigation costs, patent litigation expenditures, one or more infringement demands, one or more pending patent applications, one or more patent claims, patent invalidity, patent unenforceability, prior art status, patent legislation, proposed patent legislation, governmental regulations, proposed government regulations, technology alternatives, patent transfer transaction costs, patent licensing transaction costs, and patent valuation.

### BRIEF DESCRIPTION OF THE DRAWINGS

The accompanying drawings, which are incorporated in and form a part of the specification, illustrate the embodiments of the present invention and, together with the description serve to explain the principles of the invention.

In the drawings:

FIG. 1 is a schematic overview of the intellectual capital system of the present invention with block diagrams of the databases and program modules;

FIG. 2 is a flowchart depicting the operation of the risk evaluation module;

FIG. 3 is a flowchart depicting the operation of the risk evaluation module in conjunction with patent docketing function;

FIG. 4 is an example of a display format for a home screen of the intellectual capital management system;

FIGS. 5 and 6 are examples of risk evaluation display formats;

FIG. 7 is an example of a prior art patent docketing report; and

FIG. 8 is an example of a docketing report enhanced with a risk analysis visual indicator.

### DETAILED DESCRIPTION OF THE PREFERRED EMBODIMENT

In describing a preferred embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose.

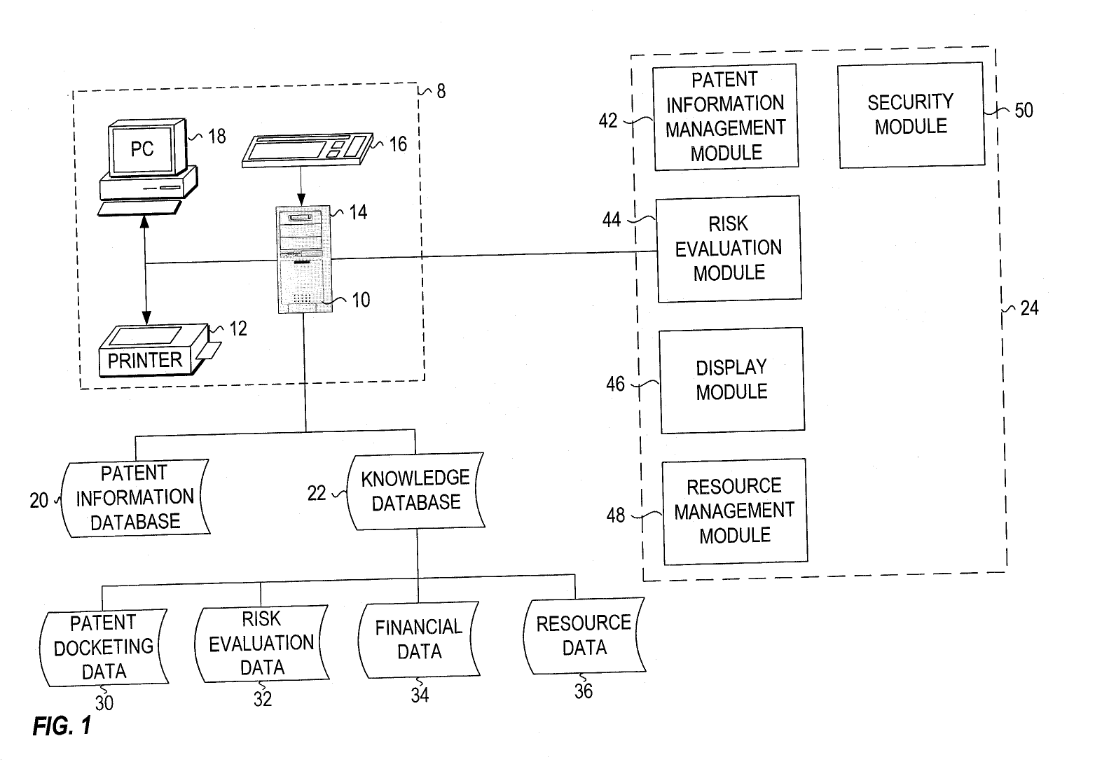

With reference to the drawings, in general, and FIGS. 1 through 8 in particular, the system, method and computer program of the present invention are disclosed.

FIG. 1 illustrates a generalized computer system suitable for use in practicing the present invention. The system includes a terminal 8 with a memory unit 10. The terminal 8 comprises a central processing unit (CPU) located on a server 14, an input device 16 which may, for example, be a keyboard, and a display 18 which may be a standard cathode ray tube monitor. The memory unit 10 may be constructed integrally with the terminal 8 within the server 14 or, alternatively, may be located remotely from the terminal 8 and accessed via telephone, Internet or other telecommunications link (not shown). Computers suitable for use in practicing this invention include personal computers, other microcomputers, minicomputers, mainframe computers, or networks or combinations of any of the above. Preferably, the terminal 10 also has an output device 15, such as printer for printing reports, graphs and charts generated by the system.

For purposes of this discussion, the memory 10 can be visualized as being divided into a number of databases and files, as illustrated. In practice, these divisions may be reflected in the physical structure of the memory 10 by providing a plurality of separate memory devices corresponding to the divisions illustrated. Alternatively, a single memory device containing all the stored information necessary for practice of the invention may be used. In the discussion which follows, the databases, and files illustrated in FIG. 1 will be discussed as separate entities by way of example and illustration only.

The memory 10 includes a patent information database 20, a knowledge database 22, and program modules 24. The patent information database 22 contains information about the patent applications and patents input into the system that customarily maintained in patent retrieval or patent docketing systems. This information includes, but is not limited to, bibliographic information such as is found on the front page of a patent. The bibliographic information may include title of the invention, inventors' names and addresses, application filing date, application serial number, patent issue date, patent number, priority application information, related-patent information such as continuation, continuation-in-part, and divisional application information, legal representative, cited references, abstract and the like. The patent information database 20 may also contain information about actions taken in such as the identification and dates of amendments, official actions, petitions, appeals and the like.

The patent information database 20 may also contain non-patent information, such as expenditures associated with a particular patent application or patent, that is not typically found in data retrieval and docketing systems. Expenditures information may include legal fees, patent offices fees, draftsman fees, translation costs, foreign agent and foreign patent office fees, and the like. This information may be used by patent information management module 42 to calculate, for example, the cost of the patent prosecution or for projecting future costs.

The knowledge database 22 is the information base that drives the system. It incorporates the data for the expert rules used in evaluating the patent portfolio risk and in carrying out docketing, budgeting and resource allocation.

The programmed knowledge, in the form of data-driven expert modules, which expertly provide the risk analysis of the patent and patent application rights are integrated into the system. An example of the programmed knowledge database, or expert modules, which are included in knowledge database 22 are illustrated in FIG. 1 which are discussed in detail below.

It should be noted that the term “expert module”, as used in this application, includes the type of deductive programming commonly referred to as an expert system. However, the term “expert module” is not intended to be limited to this particular type of programming or technique of analysis. An expert module may include a regression analysis, a discriminate function, loglinear analysis, linear programming, or any other technique which may be used by experts in analyzing and evaluating the risks associated with a particular problem or situation. Some or all of the expert rules for evaluating the risks associated may also be hard-coded in the risk evaluation program module, but is preferred to establish the rules in a database so that they may be upgraded and modified.

Knowledge database 22 is logically organized as illustrated in FIG. 1. Knowledge database 22 includes, on a first “branch” 30, information on patent application docketing. The patent docketing data 30 would contain, by way of illustration, tables of data embodying the deadlines and date calculations for actions taken in the prosecution of a patent application and payment of annuities. The data could include separate tables for each jurisdiction or country for which there is a patent or patent application in the patent information database 20. This data must be continuously updated to reflect the constantly changing regulations and national laws of the specific countries. The nature of this data is generally well known to a skilled practitioner and includes, for example, annuity deadlines, deadlines for responding to official actions from the national patent offices, permitted extension periods and the like. Optionally, the patent docketing data may be stored in the patent information database 20.

Financial information relative to the patents and patent applications in the system is maintained in a financial data module 34. This information may include revenues and expenditures associated with particular patents or patent applications such as licensing income, patent litigation costs, patent coverage relationships between the portfolio patents and products and processes, and the like. Financial data may also contain information relating to contingent or actual financial liabilities associated with third-party claims of patent infringement and the associated costs of defend such claims.

Resource data module 36 stores information about the current status and capabilities of the resources such as patent attorneys and agents, draftsman, foreign agents, and the like. This information may be used by resource management module 48 to assign and manage the flow of patent prosecution activity or by risk evaluation module 44 to assess the risks associated with having sufficient or insufficient resources to maintain and prosecute the patents and patent applications in the system. Resource data 36 may include, for example, the current workload or backlog status of each resource, the skills or experience ratings of individual resources, and the like. For example, certain patent assets may require special expertise in a particular technical field or prosecution procedure. If the resources in these areas do not have sufficient capacity, the resource risk element is increased.

Risk evaluation data module 32 contains the data used by risk evaluation program module 44 to calculate risk and, where requested, to correlate the risk against patent assets or groups of patent assets in the system. Broadly, and by way of illustration only, risk evaluation data 32 is categorized into four risk areas: patent prosecution transactional risks, resource management risks, patent asset value risks, and patent investment cost risks.

Patent prosecution transactional risks or “transaction risks” are risks associated with actions to be taken in the prosecution and maintenance of a patent application or patent. These risks vary depending on the action to taken, the time to complete or respond to an action, the availability or extension or revival mechanisms, and the like. For example, the filing deadline of a foreign or international patent application has a high degree of risk associated with the transaction, because this deadline is generally not extendable beyond one year from the priority date of the earlier filed application. In contrast, the deadline for responding to a missing parts requirement in the United States may be extended for up to five months. Generally, those actions which may not be extended or which are difficult to extend carry a higher risk than actions which may be easily extended. Another transaction risk element is the length of time to the transaction deadline correlated against the patent rights loss risk element. As the response period shortens for actions having high patent rights loss risk, the overall transaction risk increases.

Resource management risks are comprised of the risks associated with having sufficient or insufficient resources available for carry out the foreseeable patent prosecution transactions. As in the case of transaction risks, the resource management risk has a time dependent risk element.

Patent asset value risks are risks relating to the value of a patent or group of patents to a business, revenue stream such as from licensing, or a liability. Certain patents may carry higher risk because they cover core business technologies or are the underlying source for licensing revenue streams. Other patents may be of high value, because their defensive nature and the loss of patents rights could create a liability. For example, a set of patents or patent applications may be part of a cross-licensing arrangement and the loss of the patent assets would result in the loss of the licensed rights.

Another category of risk is the patent investment cost risk. This risk element takes into consideration the costs and expenditures associated with the acquisition of the patent rights. These costs may include research and development costs, patent purchase costs, patent prosecution costs and the like. For example, if the patent rights were acquired through modest investment in employee time and effort and patent prosecution costs, the risk of investment loss is relatively. (This risk does not consider valuation of the patent rights.) On the other hand, if a patent resulted from a substantial research and development expenditure and was prosecuted at considerable cost, the loss of patent rights would result in a high investment or “sunk costs” loss.

The elements of each of these risk can be determined empirically and will vary from business to business and from technology to technology. The user or the user's expert such as a valuation expert must assign weighting data to the elements in order for the system to automatically compute the associated risk. Once the weighting data is input into the system, the system may compute and display varying views of the risks.

In broad terms, the approach to evaluating a given risk which is performed by the risk evaluation module 44 includes the following steps:

1. Receiving a command to evaluate risks based user specified information contained in patent database 20;

2. Matching or correlating the attributes of the selected patents or patent applications with the corresponding risk elements from knowledge database 22;

3. Assigning weights to the identified elements on the basis of information contained in the knowledge database; and

4. Determining a risk level for the given risk by combining the assigned weights.

The system of the present invention is capable of completing this process without the aid or intervention of skilled patent portfolio manager or other personnel in some cases and, in more difficult cases, is helpful in improving the efficiency, quality, and consistency of decisions concerning the management of the portfolio.

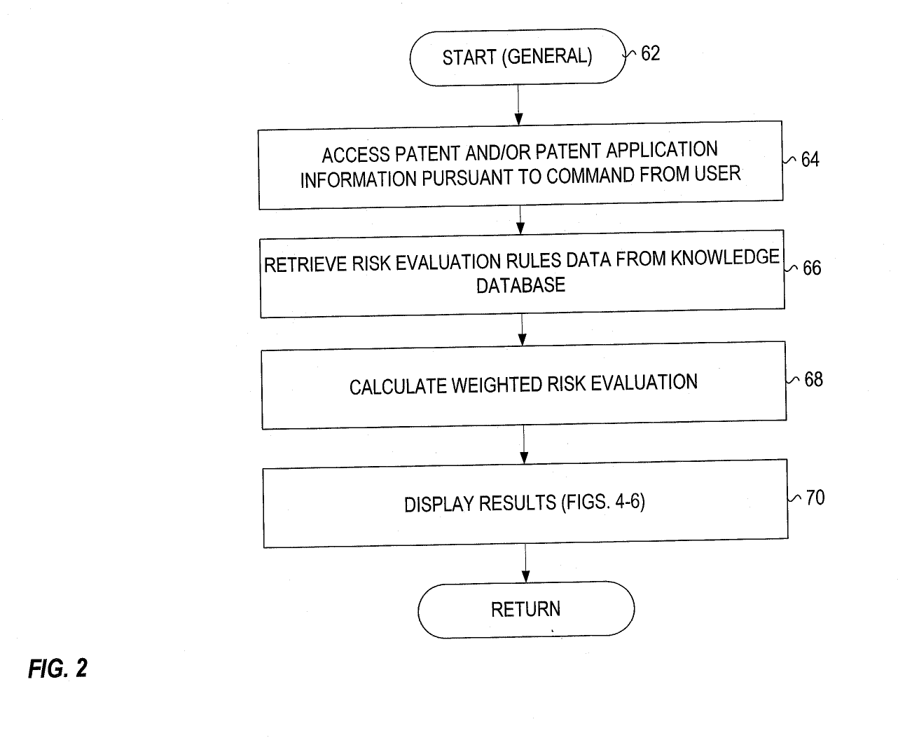

With reference to FIG. 2, the general process of the computer program is illustrated a flowchart. The process is initiated at step 62. In step 64, in response to a selection command from a user, information from the patent information database 20 on the selected patents or patent applications is retrieved. Based on the available expert modules programmed into risk evaluation module 32, risk evaluation rules are retrieved from the knowledge database 22 in step 66. The retrieved data is used to calculate the risks and assign weights to various risks as permitted by the system or requested by the user in step 68. Finally, a display program module is invoked to output the data, accessed and calculated, in a predetermined format in step 70.

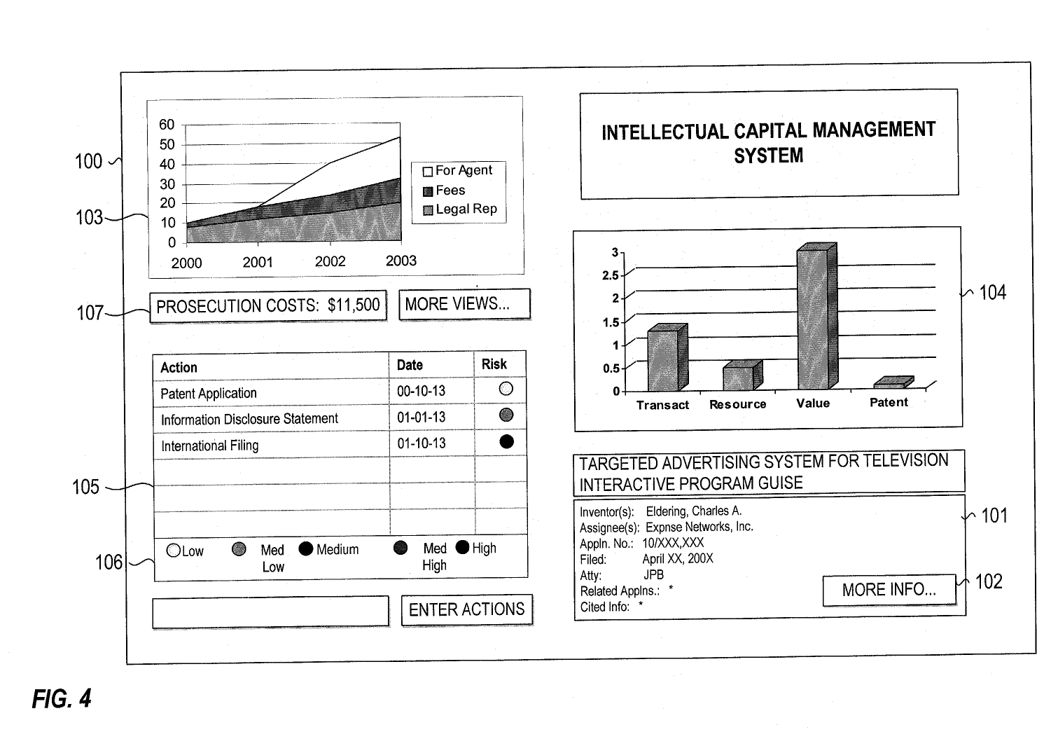

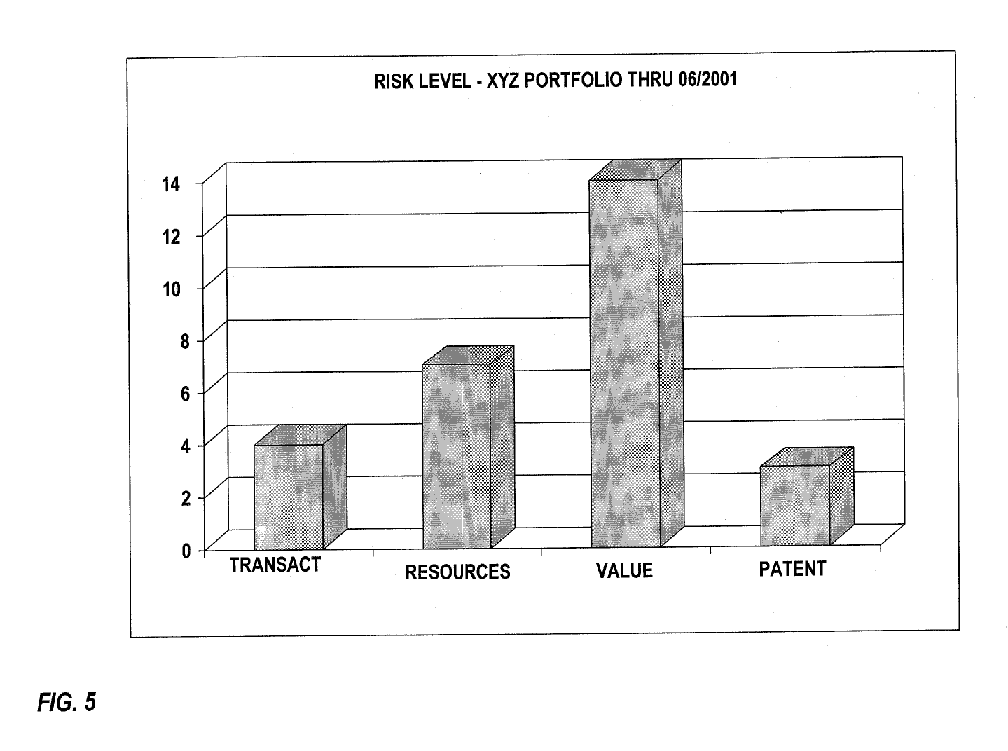

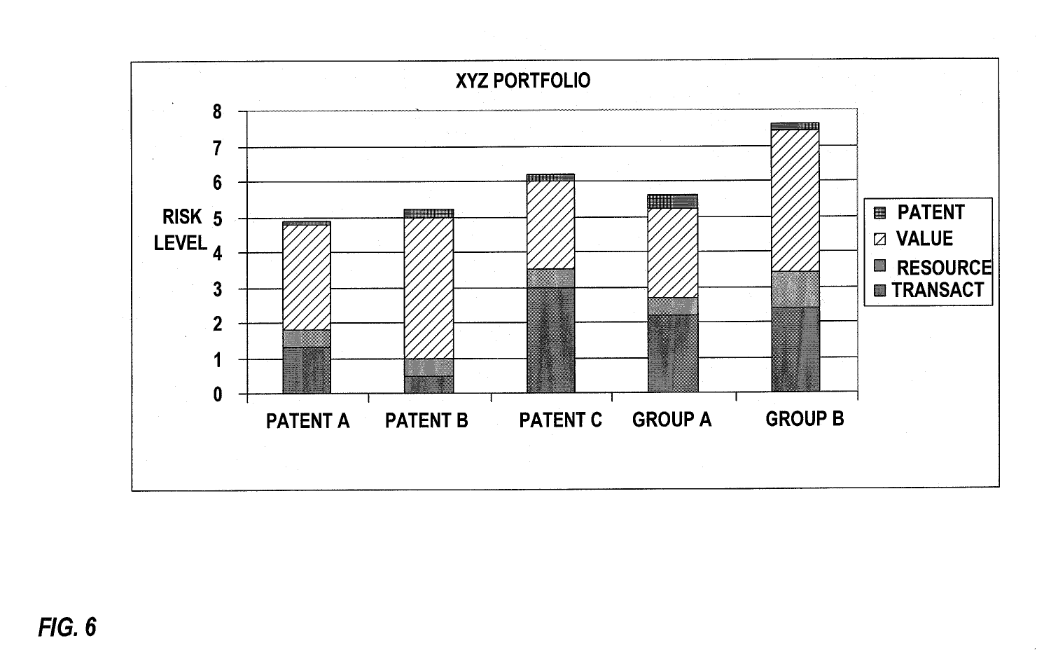

Examples of the output of the display module 46 are illustrated in FIGS. 4 through 6. FIG. 5 shows an example of a bar chart 110 of the overall transaction, resource, valuation and patent investment risks for a fictitious patent portfolio label XYZ. FIG. 6 represents stacked column bar chart 112 with each weighted risk element represented by a separate segment. FIG. 4 illustrates a display 100 of a combination of patent information data and risk evaluation data. The display 100 is a switchboard for an exemplary patent application in the system. Panel 101 displays patent bibliographic information for the selected patent application. The user may also request additional information (not shown) by activating button 102. Further information from patent information database 20 about prosecution expenditures and projected costs is displayed in panels 107 and 103. Graph 104 displays risk elements by category for the exemplary patent application similar to FIG. 5. Table 105 contains transactional data associated with the exemplary patent application. Table 105 also contains a visual risk indicator for each action or proposed action. The level of risk is explained in legend 106. The graphs, charts and tables in the application are for illustration purposes only and any suitable format as are well known in the art such as pie charts, line charts, bar charts, area charts, surface charts and the like may be used.

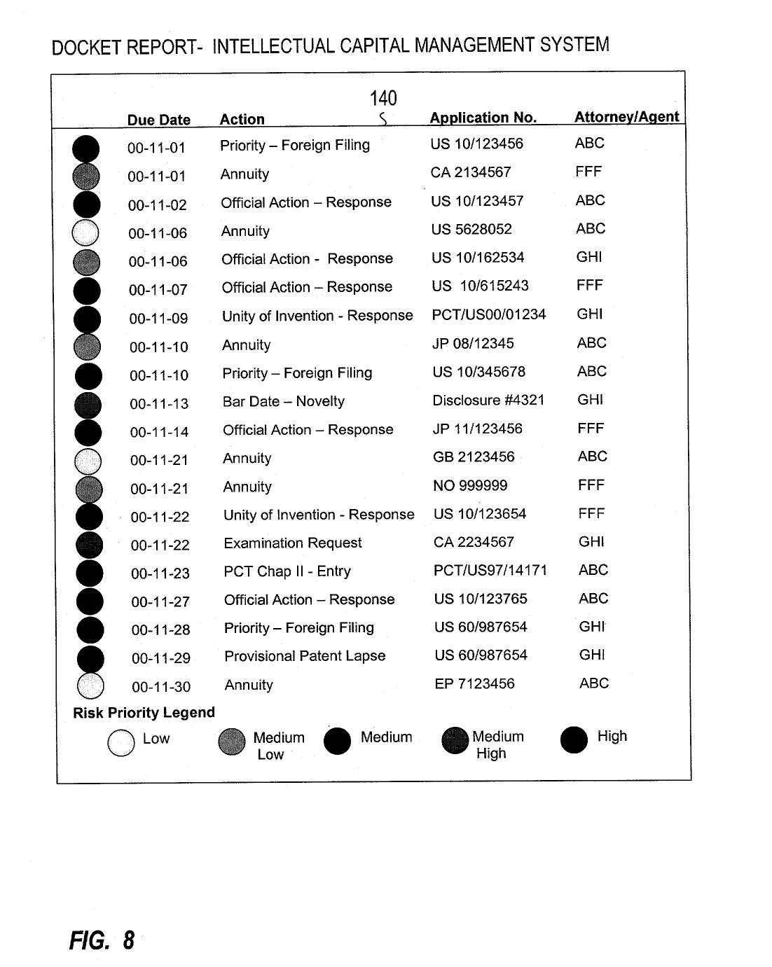

The graphical indication of the risk elements, as illustrated in table 105 of display 100 and FIG. 8, is an important aspect of the system. The graphical output assists the user in quickly assessing the information without having to analyze huge amounts of data which may or may not be easily accessible. The visual indicator also serves to sort through many pieces of information and to focus on high priority actions and assets. It also permits less sophisticated users to understand which actions and asset should have priority. Finally, another advantage of the visual indicator is that it can be used to give the user a sense of the risk associated with an aggregation of the patents or patent applications. This is particularly useful to determine the general level of risk throughout a large enterprise or in assessing the risk level of a large portfolio.

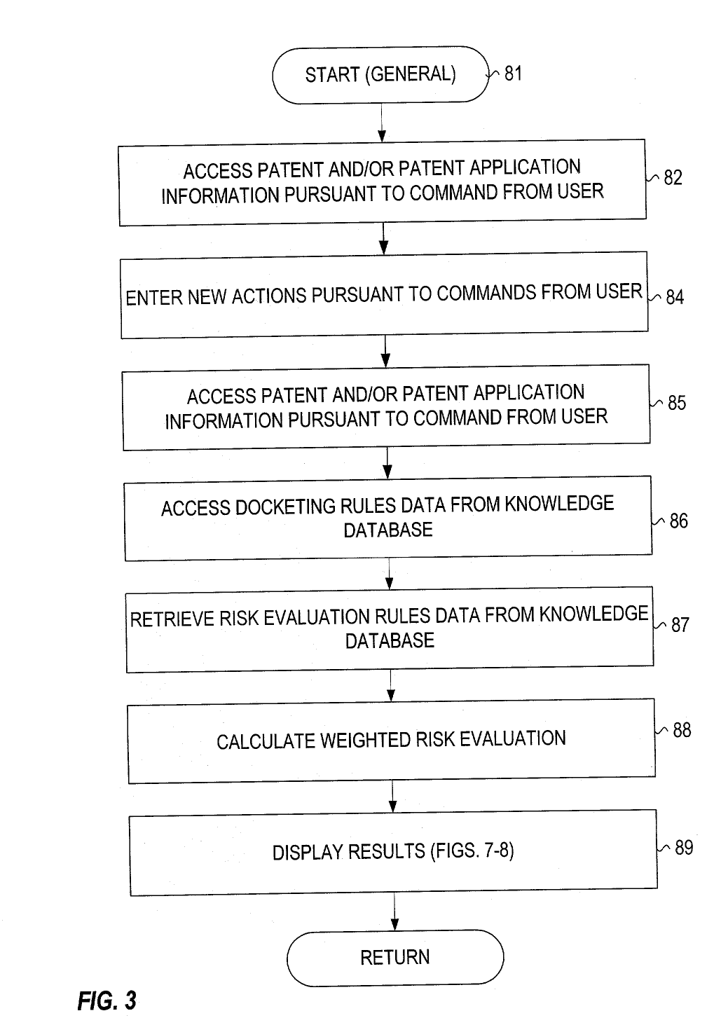

FIG. 3 illustrates the combination of risk evaluation process and docketing process. Starting at box 81, the process is initiated. The user makes a request and accesses data from patent information database 20. Optionally, in step 84, the user may enter any previously unrecorded actions associated with the selected patent or patent application. In step 85, knowledge database 22 is accessed to retrieve patent prosecution-related rules and the deadlines for the actions calculated in step 86. Optionally, the deadlines may be stored in memory (step not shown.) In step 87, the risk evaluation rules are retrieved from knowledge database 22 and the risks associated with the patent prosecution transactions is calculated as indicated in step 88. The results of the risk evaluation may be displayed as indicated in step 89 and optionally stored in memory (step not shown.) The display, directed by display module 46, may be a screen such as display 100 in FIG. 4 on monitor 18 or a report such as report 140 in FIG. 8 printed by printer 15.

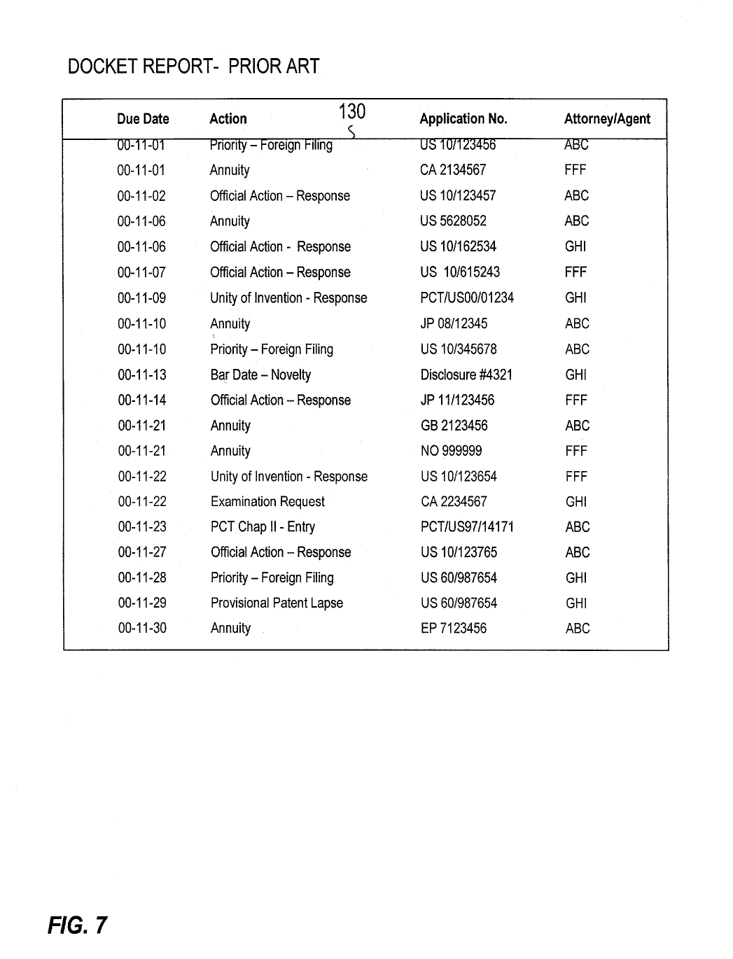

FIGS. 7 and 8 illustrate docket reports with and without the graphical indication of risk. Report table 130 is representative of a prior art docket report in which the action deadlines, deadline dates, application identifier and responsible attorney or agent are represented textually. In order for the user to assess the risk of different deadlines, the user must interpret the text, i.e. the type of action due and the rules and regulation associated with the action, to determine which actions should be given priority. Also, the user must personally know something about the history of each patent application in order to assess the valuation and investment risks. In contrast, table 140 in the docket report in FIG. 8 illustrates the use of risk assessment visual indicators according to the present invention. Each item in table 140 has risk indicator next to the deadline date which graphically communicates a risk evaluation to the user. This visual indicator helps the user sift through the clutter of the report and point out the high priority actions and deadlines.

The output of the risk evaluation may be used in decisional analysis in managing the patent portfolio such as allocation of resources to specific patent applications or sub-portfolios. Decision analysis is a quantitative technique for making decisions about complex problems in situations of uncertainty. Use of decision analysis techniques normally involves five steps: (1) determining the possible options; (2) determining the probabilities of occurrence associated with each of the options; (3) quantifying the results of each of the options; (4) calculating the value of each of the options; and (5) determining the best option to select for a given situation and evaluating the effects of changes in the situation upon given options.

Thus a patent portfolio manager when comparing two or more patent applications or patent portfolios may determine that greater resources should be devoted to one of the patent portfolios, because of the higher risks associated with the portfolio. For example, one portfolio may have very high valuation risk associated with it, because of a lucrative licensing royalty stream derived from the portfolio. Similarly, a manager may decide to defer payment of a set of patent annuities, because the value of the patents are minimal and the annuities may be paid later with extensions or surcharges.

Although this invention has been illustrated by reference to specific embodiments, it is not intended that the invention be limited to these embodiments. It will be apparent to those skilled in the art that various changes and modifications may be made which clearly fall within the scope of the invention. The invention is intended to be protected broadly within the spirit and scope of the appended claims.

What is claimed is:

1. A system for processing data, comprising:
means for accessing a first database of information representative of patent applications or patents;
means of accessing a second database of information relating to risk elements associated with patent rights;
means for automatically evaluating the potential risks of at least one patent application, group of patent applications, patent, or group of patents represented in said first database.

2. The system of claim 1, wherein said system further comprises:
means for displaying risk information using a graphical display based on the potential risks associated with said at least one patent, group of patent applications, patent, or group of patents.

3. The system of claim 1, wherein said risk evaluating means comprises:
means for correlating selected risk elements from said second database with information accessed from said first database.

4. The system of claim 1, wherein said risk evaluating means comprises:
means for assigning a weight to at least one of said selected risk elements on the basis of predetermined relationships existing between the elements of information in said second database.

5. The system of claim 1, wherein said risk evaluating means comprises:
means for determining a risk level classification for said at least one selected risk element based on said assigned weight.

6. The system of claim 1, wherein said at least one selected risk element is associated with one or more of the following criteria:
patent status, patent prosecution status, one or more patent prosecution transactions, patent prosecution resources, financial resources, patent prosecution costs, patent prosecution expenditures, patent licensing status, patent licensing revenue, patent licensing obligations, patent acquisition costs, invention development costs, invention development expenditures, invention ownership status, patent litigation status, patent litigation costs, patent litigation expenditures, one or more infringement demands, one or more pending patent applications, one or more patent claims, patent invalidity, patent unenforceability, prior art status, patent legislation, proposed patent legislation, governmental regulations, proposed government regulations, technology alternatives, patent transfer transaction costs, patent licensing transaction costs, and patent valuation.

7. The system of claim 1, wherein said second database further comprises information relating to patent prosecution transactions, and wherein said system further comprises:
means for automatically evaluating potential patent prosecution transactions associated with said at least one patent application, group of patent applications, patent, or group of patents to provide information about potential patent prosecution transactions relative to said at least one patent application, group of patent applications, patent, or group of patents;
means for selecting all or part of said potential patent prosecution transaction information; and
means for displaying said selected potential patent prosecution transaction information.

8. The system of claim 7, wherein said risk evaluating means comprises:
means for evaluating risks associated with said potential patent prosecution transactions.

9. he system of claim 8, wherein said display means comprises:
means for displaying risk information using a graphical display based on the potential risks associated with said potential patent prosecution transactions.

10. A method of processing data, comprising the steps of:
accessing a first database of information representative of patent applications or patents;
accessing a second database of information relating to risk elements associated with patent rights;
automatically evaluating the potential risks of at least one patent application, group of patent applications, patent, or group of patents represented in said first database.

11. The method of claim 10, wherein said method further comprises the step of:
displaying risk information using a graphical display based on the potential risks associated with said at least one patent, group of patent applications, patent, or group of patents.

12. The method of claim 10, wherein said risk evaluating step comprises:
correlating selected risk elements from said second database with information accessed from said first database.

13. The method of claim 10, wherein said risk evaluating step comprises:
assigning a weight to at least one of said selected risk elements on the basis of predetermined relationships existing between the elements of information in said second database.

14. The method of claim 10, wherein said risk evaluating step comprises:
determining a risk level classification for said at least one selected risk element based on said assigned weight.

15. The method of claim 10, wherein said at least one selected risk element is associated with one or more of the following criteria:
patent status, patent prosecution status, one or more patent prosecution transactions, patent prosecution resources, financial resources, patent prosecution costs, patent prosecution expenditures, patent licensing status, patent licensing revenue, patent licensing obligations, patent acquisition costs, invention development costs, invention development expenditures, invention ownership status, patent litigation status, patent litigation costs, patent litigation expenditures, one or more infringement demands, one or more pending patent applications, one or more patent claims, patent invalidity, patent unenforceability, prior art status, patent legislation, proposed patent legislation, governmental regulations, proposed government regulations, technology alternatives, patent transfer transaction costs, patent licensing transaction costs, and patent valuation.

16. The method of claim 1, wherein said second database further comprises information relating to patent prosecution transactions, and wherein said method further comprises the steps of:
automatically evaluating potential patent prosecution transactions associated with said at least one patent application, group of patent applications, patent, or group of patents to provide information about potential patent prosecution transactions relative to said at least one patent application, group of patent applications, patent, or group of patents;
selecting all or part of said potential patent prosecution transaction information; and
displaying said selected potential patent prosecution transaction information.

17. The method of claim 16, wherein said risk evaluating step comprises:
evaluating risks associated with said potential patent prosecution transactions.

18. The method of claim 17, wherein said display step comprises:
displaying risk information using a graphical display based on the potential risks associated with said potential patent prosecution transactions.
